(19) United States
(12) Patent Application Publication
(10) Pub. No.: US 2014/0074631 A1
(43) Pub. Date: Mar. 13, 2014

(54) DIGITAL RECEIPT ROUTING FEATURE

(71) Applicants: Glenn Grossman, Matthews, NC (US); Matthew A. Calman, Charlotte, NC (US)

(72) Inventors: Glenn Grossman, Matthews, NC (US); Matthew A. Calman, Charlotte, NC (US)

(73) Assignee: BANK OF AMERICA CORPORATION, Charlotte, NC (US)

(21) Appl. No.: 13/606,576

(22) Filed: Sep. 7, 2012

(51) Int. Cl. G06Q 40/00; G06Q 20/20

(52) U.S. Cl. 705/16; 705/39

(57) ABSTRACT

Systems, methods, and computer program products are provided for routing digital receipts. In the systems and methods, transaction data is received, where the transaction data includes a receipt authorization code. The receipt authorization code is associated with one or more rules that include certain transaction criteria. The transaction criteria and the transaction data are compared to determine that the transaction complies with the one or more rules. Receipt data for the digital receipts is determined based on the terms of the one or more rules. In the systems and methods, digital receipts are provided to the user and include at least some of the receipt data.

### BACKGROUND

Consumers often make many purchases using different forms of payment at various locations and stores during any given time. Records of the purchases are typically provided by merchants at the point of sale in the form of a paper receipt. Keeping track of purchases using these paper receipts can be challenging because the paper receipts may easily be misplaced or damaged and such receipts only contain a limited amount of information pertaining to a single transaction. Further, the information contained in paper receipts are static and cannot be easily updated or modified.

### BRIEF SUMMARY

Embodiments of the present invention provide a system for routing digital receipts to a user, the system comprising: a computer apparatus including a processor and a memory; and a digital receipt router software module stored in the memory, comprising executable instructions that when executed by the processor cause the processor to: receive transaction data associated with a transaction comprising a receipt authorization code for authoring delivery of the digital receipts, wherein the receipt authorization code is associated with a first rule comprising a first set of transaction criteria; compare the first set of transaction criteria and the transaction data; determine that the transaction complies with the first rule based on the comparison of the first set of transaction criteria and the transaction data; and segregate receipt data from the transaction data based on the first rule. The processor being further configured to send the receipt data to a receipt distribution system that is in communication with the system.

In some embodiments of the system, the receipt authorization code is associated with a second rule for modifying the data to be included in the digital receipts, the second rule comprising a second set of transaction criteria. In other embodiments, at least a portion of the second set of transaction criteria is the same as at least a portion of first set of transaction criteria. The module is further configured to: compare the transaction data and the second set of transaction criteria; determine that the transaction complies with the second rule; modify the receipt data in response to determining that the second set of transaction criteria complies with the second rule; and send the modified receipt data to a distribution system that is in communication with the system. The module is further configured to: identify purchased items of the transaction; and segregate the purchased items into one or more categories.

In further embodiments of the system, the transaction data is received from a point of sales device that is in communication with the system. In still other embodiments, the first set of transaction criteria comprises at least one of a purchase amount, a purchase frequency, a number of purchase items, a type of purchase item, a merchant identity, a period of time of purchase, and rewards.

Embodiments of the present invention further provide a computer program product for routing digital receipts to a user, the computer program product comprising: a computer readable storage medium having computer readable program code embodied therewith, the computer readable program code comprising: a computer readable program code configured to receive transaction data comprising a receipt authorization code for authorizing delivery of the digital receipts, wherein the receipt authorization code is associated with a first rule comprising a first set of transaction criteria; a computer readable program code configured to compare the first set of transaction criteria and the transaction data; a computer readable program code configured to determine that the transaction complies with the first rule based on the comparison of the first set of transaction criteria and the transaction data; and a computer readable program code configured to segregate receipt data from the transaction data based on the first rule.

In further embodiments of the computer program product, a computer readable program code configured to send the receipt data to a receipt distribution system that is in communication with the system is provided. In some embodiments, the receipt authorization code is associated with a second rule comprising second set of transaction criteria for modifying the data to be included in the digital receipts. The computer program product further comprising a computer readable program code configured to: compare the transaction data and the second set of transaction criteria; determine that the transaction complies with the second rule; modify the receipt data based on terms of the second rule; and send the modified receipt data to a distribution system that is in communication with the system.

In some embodiments of the computer program product, the first set of transaction criteria comprises at least one of a purchase amount, a purchase frequency, a number of purchase items, a type of purchase item, a merchant identity, a period of time of purchase, and rewards. In other embodiments, at least a portion of the second set of transaction criteria is the same as at least a portion of first set of transaction criteria. In still other embodiments, the transaction data is received from a point of sales device that is in communication with the system.

Embodiments of the present invention further provide a computer implemented method for routing digital receipts to a user, the method being performed by a computer processor, wherein the computer processor operates on specifically configured computer program code that cause the processor to perform the operations of: receiving transaction data associated with a transaction comprising a receipt authorization code for authoring delivery of the digital receipts, wherein the receipt authorization code is associated with a first rule comprising a first set of transaction criteria; comparing the first set of transaction criteria and the transaction data; determining that the transaction complies with the first rule based on the comparison of the first set of transaction criteria and the transaction data; and segregating receipt data from the transaction data based on the first rule. The method further includes sending the receipt data to a receipt distribution system that is in communication with the system.

In some embodiments of the method, the receipt authorization code is associated with a second rule comprising second set of transaction criteria for modifying the data to be included in the digital receipts. In some embodiments, the processor being further configured to perform the operations of: comparing the transaction data and the second set of transaction criteria; determining that the transaction complies with the second rule; modifying the receipt data based on terms of the second rule; and sending the modified receipt data to a distribution system that is in communication with the system. In other embodiments, wherein the first set of transaction criteria is different from the second set of transaction criteria.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a payment system and environment in accordance with various embodiments of the invention;

FIG. 2 is a flowchart of a system and method for routing digital receipts in accordance with various embodiments of the invention;

FIG. 3A is a flowchart of a system and method for routing digital receipts in accordance with various embodiments of the invention;

FIG. 3B is a flowchart of a system and method for routing digital receipts in accordance with various embodiments of the invention;

FIG. 4 provides a block diagram illustrating a digital receipt routing system and environment in accordance with various embodiments of the invention;

FIG. 5 provides a block diagram illustrating the first POS system of FIG. 4, in accordance with an embodiment of the invention;

FIG. 6 provides a block diagram illustrating the first user's personal computing device of FIG. 4, in accordance with an embodiment of the invention;

FIG. 7 provides a block diagram illustrating the first financial institution's online banking system of FIG. 4, in accordance with an embodiment of the invention; and

FIG. 8 provides a block diagram illustrating the payment system of FIG. 4, in accordance with an embodiment of the invention.

### DETAILED DESCRIPTION OF EMBODIMENTS OF THE INVENTION

The embodiments presented herein are directed to systems and methods for routing one or more digital receipts. A receipt authorization code for authorizing digital receipts is linked to one or more financial accounts and/or payment vehicles. The receipt authorization code includes one or more rules and the criteria for the one or more rules are compared with transaction data associated with a particular transaction. In some instances, at least some of the transaction data is forwarded to a system that distributes a digital receipt to the user.

As will be appreciated by one skilled in the art, aspects of the present embodiments of the invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the invention are described below with reference to flowchart illustrations and/or block diagrams of methods, apparatus (systems) and computer program products according to embodiments of the embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like.

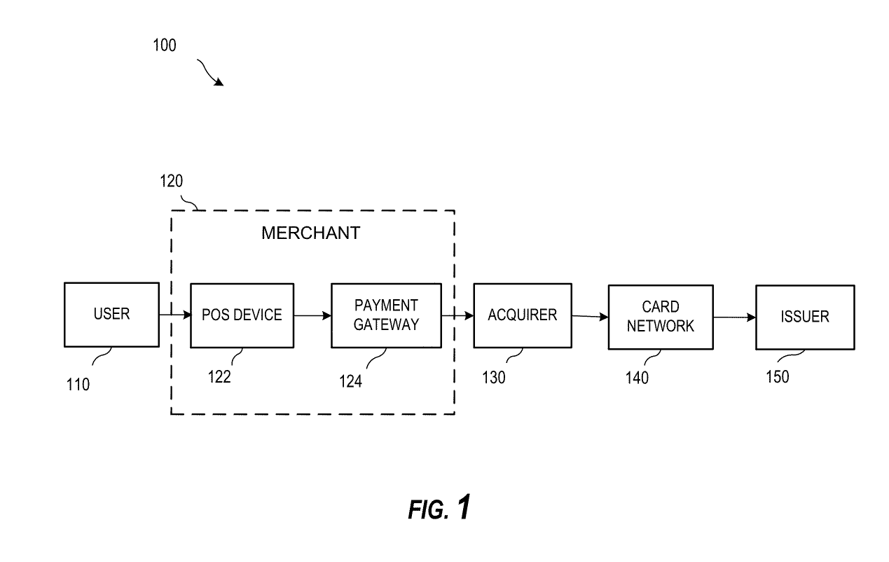

FIG. 1 is a block diagram providing an overview of system and environment 100 for making a payment at a point of sale. A user 110 provides a payment vehicle or method such as cash, mobile payment, credit card, and/or loyalty card at a point of sale. The user 110 may, for example, swipe a credit card, input a code, or communicate via near field communication using a mobile device with a point of sale (POS) device 122. The POS device 122 transmits data obtained from the payment vehicle such as a bank identification code or issuer identification code, and/or a payment authorization code along with other transaction data such as purchase amount to a payment gateway 124. In some embodiments, the point of sale device 122 and/or payment gateway is maintained or otherwise associated with a merchant 120. As discussed in greater detail below, the transmitted transaction data may include a receipt authorization code for authoring delivery of digital receipts. The receipt authorization code can be provided by the user 110, the POS device 122, an acquirer 130, a card network 140, and/or an issuer 150.

The transaction data is transmitted to the acquirer 130 (e.g., a financial clearing house). The system of the acquirer 130 transmits the transaction data to the card network 140. In some embodiments, the card network 140 transmits the transaction data to the issuer 150. The issuer 150 may include, for example, the financial institution associated with the payment vehicle and/or user 110 or any other entity that is authorized to approve or reject payments. For example, in a closed looped system, the issuer 150 may be a university associated with a student/employee payment card, a merchant, a tech provider, and the like.

In other embodiments, the acquirer 130 transmits the transaction data to the issuer 150. The issuer 150 determines whether to approve transmittal of the payment associated with the payment vehicle or reject the transmittal of the payment. The system of the issuer 150 sends the issuer's response back to the POS device 122 via the system of the acquirer 130 or card network 140. If the response from the issuer 150 authorizes payment using the payment vehicle, the POS device 120 accepts the payment. The POS device 120 declines payment if the response from the issuer 150 is negative.

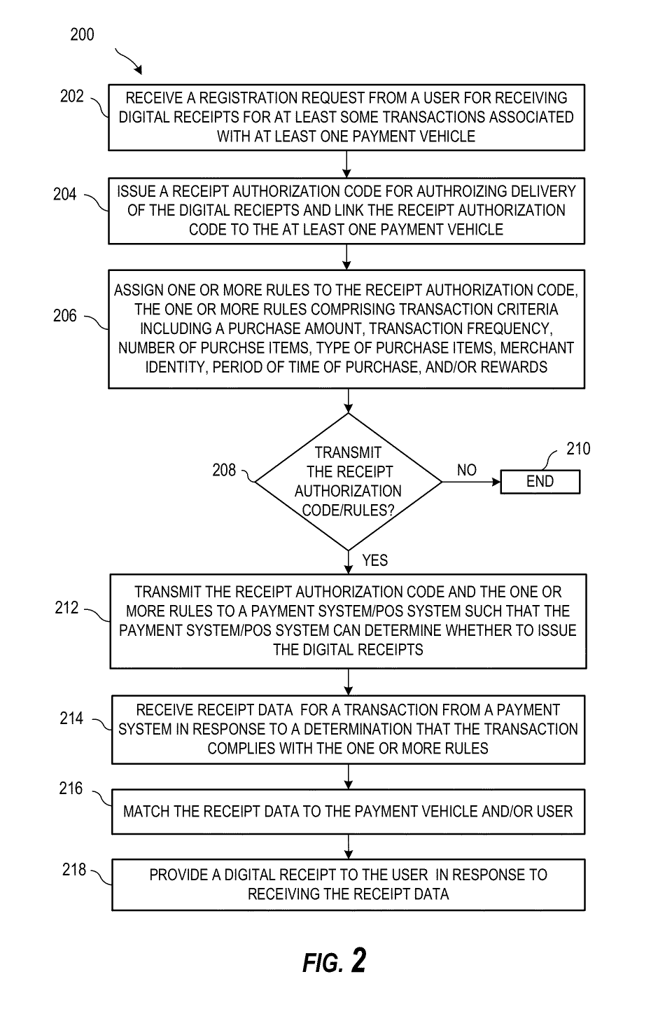

FIG. 2 is a flowchart providing an overview of a system and method 200 for routing digital receipts. It will be understood that one or more devices, such as one or more mobile device and/or one or more other computing devices and/or servers, can be configured to perform one or more steps of the system and method 200. In some embodiments, the one or more devices performing the steps are associated with a financial institution. In other embodiments, the one or more devices performing the steps are associated with an issuer (e.g., the issuer 150), an acquirer (e.g., the acquirer 130), a merchant (e.g., the merchant 122), a third party, and/or user.

As illustrated at block 202, the system 200 receives a registration request from a user for receiving digital receipts for at least some transactions associated with at least one payment vehicle. The user includes a customer of a financial institution, a financial account holder, an agent of an account holder, a user associated with payment vehicle, and the like. Exemplary payment vehicles include cash, check, credit cards, debit cards, gift cards, person-to-person transfers, mobile payments, or any other type of payment. It will be understood that as used herein, payment vehicles include any form of payment and certain types of vehicles associated with a particular form of payment. For example, payment vehicles may further include loyalty cards, store cards, reward cards, discount cards, or any other type of vehicle or process that is used at a point of sale.

In some embodiments, the user logs into an online banking system to place the registration request. The registration request includes account data, payment vehicle data, user preferences, and the like. For example, the registration request can include account numbers, aliases for making person to person payments, credit card data, debit card data, mobile payment vehicle data, transaction criteria, receipt delivery preferences, receipt formatting preferences, receipt data preferences, user preferences, and the like. The digital receipt includes electronic documents, scanned images, text files, audio files, or combinations thereof.

In some embodiments, the system 200 identifies merchants that have a digital receipt program. For example, the system 200 may identify merchants in a specific geographical area, identify merchants based on user input, and/or identify merchants based on the user's transaction history. The system 200 may, for example, notify the user that 90% of merchants that the user has been associated with in the past or that the user specifies have a digital receipt program. In such cases, the user may indicate that they would prefer to use or to not use one or more of digital receipt programs associated with the identified merchants. For example, the user may prefer to use the digital receipts program associated with all gas stations that have the digital receipts program, but may prefer not to use the merchant's digital receipts program at all home improvement stores. The user may prefer paper receipts or may prefer to use the receipt authorization code discussed below at specific merchants or for specific transactions.

As illustrated at block 204, the system 200 issues a receipt authorization code for authorizing delivery of the digital receipts and links the receipt authorization code to the at least one payment vehicle. In some embodiments, the receipt authorization code is linked to an account and/or a payment vehicle. For example, the receipt authorization code may be linked to a checking account, mobile payment account, a credit card account, a debit card account, a particular payment vehicle, and the like. In another example, the receipt authorization code may be linked to an account that is associated with one or more payment vehicles. In still another example, the receipt authorization code may be linked to a person to person account for processing a person to person payment. In such cases, both the user and the merchant may have a person to person account that allows the user to transfer a payment amount to the merchant's person to person account, or receive a payment amount (e.g., a refund) from the merchant's person to person account. In order to transfer a payment amount, the user and/or merchant enters an alias either at a POS device or a mobile device that is communication with a POS system to transfer funds.

In some embodiments, a first alias is associated with a user. For example, the first alias may be generated by the user to send a payment without disclosing a payment account. Instead of using a credit card number, for example, a user may input an alias to make in-store or on online purchases. In other embodiments, a second alias is associated with a recipient (e.g., the merchant). The second alias, for example, may include a POS device identifier and a payment amount associated with that POS device, or a mobile phone number. The alias may be any unique identifier other than the user's financial institution account number. Typically, the alias is an identifier that friends, family, and/or other members of the public uniquely associate with the user or any entity transferring or receiving a payment. For example, the alias may be a mobile telephone number, an email address, a social networking ID, a name, an address, a URL (uniform resource locator) address, a logo, a brand, a picture, graphical art, a trade name, a trade mark, a device, a loyalty card number, a merchant identifier, and/or any other textual, graphical, or visual indicator.

The receipt authorization code, in some embodiments, authorizes the routing or delivery of a digital receipt to the user. The digital receipt may be in place of or in addition to a paper receipt. The receipt authorization code, in some exemplary embodiments, is in embedded in the transmitted purchase authorization code. For example, the receipt authorization code may consist of one or more numbers such as “1” or “0” that is attached to the end of the purchase authorization code. The “0” may, for example, indicate that delivery of digital receipts is not authorized for the payment vehicle and the “1” may indicate that delivery of digital receipts is authorized for at least some transactions associated with the payment vehicle.

In some embodiments, the receipt authorization code is provided by the user. The receipt authorization code, in some embodiments, is embedded in the payment vehicle such as a credit card or loyalty card, and transmitted to the POS device when the user presents the card for payment. In other embodiments, the receipt authorization code is provided by the mobile device of the user. For example, when making mobile payments, the mobile device may transmit the receipt authorization to a POS device by near field communication (NFC), quick response (QR) code, audio signal, wireless application protocol, and other communication technologies.

In still further embodiments, the receipt authorization code comprises a receipt code, such as an identifier or PIN. In one exemplary embodiment, the user inputs the receipt PIN in the POS system at the point of sale. The user may enter the PIN into a key pad associated with a POS device. Such a receipt code can be used for cash, check, person-to-person, or card based transactions or any other transaction where a digital receipt is desired.

As illustrated at block 206, the system 200 assigns one or more rules to the receipt authorization code, where the one or more rules comprises transaction criteria, which includes a purchase amount, purchase frequency, number of purchase items, type of purchase items, merchant identity, period of time of purchase, and/or rewards. The system 200 can assign default rules or customized rules. For example, the system 200 may assign the one or more rules based on historical transaction trends of the user, projected transaction trends of the user, account polices associated with payment vehicles, user preferences, or combinations thereof. In other embodiments, the user includes the transaction criteria associated with the receipt authorization code in the registration request. For example, the user may specify certain criteria or combinations of criteria that must be met in order to comply with the one or more rules.

The purchase amount includes, for example, a transaction amount, a total transaction amount range, a total transaction amount limit, a purchase item amount for one or more items of a transaction, a purchase item amount range, a purchase item amount limit, a transaction amount trend, and the like. The one or more rules may include a purchase amount rule, for example, where a transaction amount must be equal to, greater than, or less than a certain transaction amount limit or transaction amount range to meet the requirements of the rule. In an exemplary transaction amount trend rule, the rule may require that a current transaction amount be equal to, greater than, or less than a previous transaction amount or range associated with a transaction that occurred during a previous period of time. For example, if certain transactions have a transaction amount of $25 during a previous month or week, then the same or similar transactions that occur during the current month or other period of time must be in the range of $20-$30 in order to comply with the rule. The previous transactions may be identified based on the at least one payment vehicle linked to the receipt authorization code, or the previous transaction may be identified based on various transaction criteria such as merchant identity.

The transaction frequency includes the number of purchases or other transactions that occur during a period of time. For example, the one or more rules may require that the number of transactions (e.g., withdrawals, deposits, or purchases) for a particular account or payment vehicle during a specific period of time be equal to, greater than, or less than a predetermined number. For example, the rule may require that a particular credit card be used three times in one day or in one week in order to receive authorization for digital receipts, where the particular credit card may be linked or not linked to the receipt authorization code.

The user and/or system 200 can also use the digital receipts to track the transaction frequency to determine how often a particular payment vehicle is used to adjust his or her transaction behavior. In one example, frequent use of a particular debit card of the user may be tied to higher interest rate for a checking account while an increase in the amount spent using a particular credit card may result in higher earned rewards. In such cases, the system 200 may prompt the user to increase the use the debit card for making purchases that have a total amount under $20 or increase the use of the debit card for making cash withdrawals to pay for purchases under $20, while decreasing the use of the credit card for purchases under $20. The system 200 may also identify certain types or groups of transactions that are typically under $20. For example, the user may typically spend $3 to $10 at a coffee shop, but always spend over $25 at gas stations.

The transaction criteria for the one or more rules, in some embodiments, requires that the number of purchase items for one or more transaction be equal to, greater than, or less than a certain purchase item number. The purchase item number includes a total number of purchase items in one or more transactions, a category of purchase items, an average number of purchase items, a percentage of purchase items, and the like. For example, the one or more rules may require that half of the purchase items be over $50 each, or that a certain number of purchase items be food items, or that the total number of items purchase be over ten for one particular purchase. The type of purchase items includes a certain category of purchase items, a specific type of purchase item, a particular brand of purchase items, and the like. For example, the one or more rules may require that at least one purchase item of a transaction have a specific label code, bar code, product code, SKU code and the like. The purchase item criteria associated with the one or more rules, in further examples, may be based on reviews of the items purchased. In another example, if a certain item or a certain category of items have been known to have defects, have a high rate of return by purchasers, are in high demand, are sold in limited quantities, and/or are associated with a strict return policy, such items may be included in the purchase criteria of the one or more rules.

In further embodiments, the one or more rules require that a specific merchant be associated with a transaction to authorize delivery of the digital receipts for that transaction. For example, the rules may indicate that all purchases associated with a gas station may be authorized for digital receipt routing, while authorization for issuing digital receipt to the user all purchases associated with a grocery store may be declined. The merchant include brick and mortar merchants, online merchants, virtual merchants, and the like. The merchant identity includes merchant identification codes, merchant addresses, merchant logos, QR code, bar code, merchant names, and the like. In some embodiments the merchant information associated with the one or more rules may include information relating to prior transactions associated with a particular merchant. For example, if the user has returned, disputed a transaction, or received a refund from the merchant during a previous period of time (e.g., the last six months), the merchant may be tagged and included in the one or more rules. In another example, the merchant information associated with the one or more rules may be based on publically available merchant reviews, whether the merchant is going out of business, and the like. In such cases, authorization to deliver the digital receipts ensures that the user has a record of the receipt in case a purchased item needs to be returned or in case a dispute arises with the merchant.

In still further embodiments, the transaction criteria of the one or more rules comprise reward information. For example, the receipt authorization code may be linked to a reward card identifier such that the one or more rules may include certain reward card numbers. The one or more rules, in some instances, may include reward thresholds such as maximum and/or minimum earned reward point limits, a period of time for using rewards, type of rewards offered, and the like. Digital receipts can be provided to the user in such cases so that the user is kept informed about the progress of the rewards associated with a particular payment vehicle or merchant.

It will be understood that the transaction criteria of the one or more rules may include any number or combinations of transaction criteria described herein. Additional transaction criteria such as the geographical location of the merchant, the geographical location where the transaction occurs, current and previous spending trends, user preferences, account balances, interest rates, type of account, and the like may also be included in the one or more rules.

As illustrated in block 208, the system 200 determines whether to transmit the receipt authorization code and the one or more rules to another system. If the system 200 decides not to transmit the receipt authorization code and the one or more rules, the process ends as shown in block 210. In one exemplary embodiment, the system 200 receives transaction data including the identity of the merchant or other entity associated with the transaction from an acquirer or POS system. Based on the identity of the merchant, acquirer, or other entity involved in the transaction, the system 200 may, for example, determine that the merchant or other entity already has a digital receipt program in place. In such cases, the system 200 may decide not to transmit the receipt authorization code and rules to the other system, or the system 200 may determine that the rules of the receipt authorization code should be applied to a particular transaction. For example, the user preferences may specify to always use the receipt authorization code and associated rules for all transaction or selected transactions associated with a particular payment vehicle such that the receipt authorization code takes precedent over any other digital receipt program.

As illustrated in block 212 and in response to determining that the receipt authorization code and the one or more rules will be transmitted, the system 200 transmits the receipt authorization code and the one or more rules to a payment system and/or POS system such that the payment system and/or of POS system can determine whether to issue the digital receipts. For example, the system 200 may transmit the receipt authorization code and associated rules with payment authorization upon receiving a request from a POS device to authorize payment for a transaction associated with a particular credit card. In other instances, the receipt authorization code and rules may be sent separate from payment authorization. In still other embodiments, the system 200 may transmit the receipt authorization code and associated rules to any entity involved in the transaction such as the issuer, the acquirer, the merchant, or the user. The system of any entity that receives the receipt authorization code and rules may, for example, store the code and rules in a database such that when a transaction occurs, any entity involved in the payment transaction may have access to the receipt authorization code and rules for determining whether routing of a digital receipt to a user is authorized for the transaction. In this way, the system 200 does not need to send the receipt authorization code and the one or more rules to the payment system or other system for every transaction associated with a particular payment vehicle.

In other embodiments, the user transmits the receipt authorization code and/or the one or more rules to a payment system and/or POS system. For example, the user may transmit the authorization code and/or the rules to a POS device using a NFC enabled mobile device. In still further embodiments, the merchant transmits the authorization code and/or the one or more rules to the payment system. In other embodiments, the acquirer associated with the transaction transmits the authorization code and/or the one or more rules to the payment system.

As illustrated in block 214, the system 200 receives receipt data for a transaction from a payment system in response to a determination that the transaction complies with the one or more rules. In some embodiments, the payment system comprises a third party system. For example, the payment system may be a clearing house, a partner, vendor, or other third party that processes payments and that is separate from a financial institution or POS device. In other embodiments, the payment system is associated with a financial institution. The payment system may, for example, be a part of an online banking system or otherwise associated with the online banking system. The payment system is discussed in further detail below.

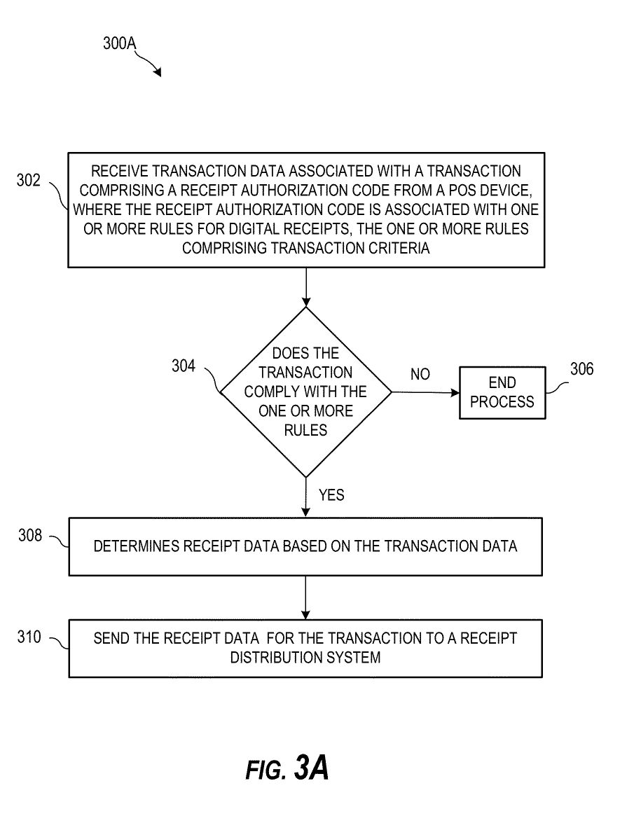

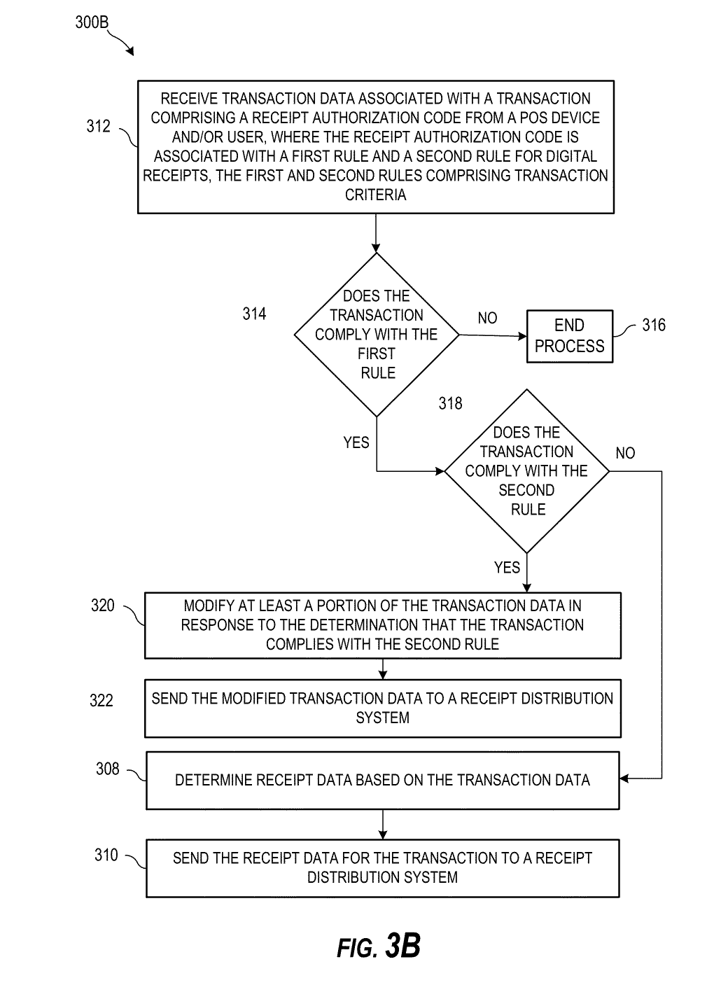

In some embodiments, the system 200 determines that the transaction complies with the one or more rules. In other embodiments, the payment system determines that the transaction complies with the one or more rules. The payment system compares transaction data associated with the transaction and the transaction criteria of the one or more rules to make the determination as described in more detail below with regard to FIGS. 3A-3B. In still other embodiments, a POS device that is in communication with the system 200 and/or payment system determines that the transaction complies with the one or more rules.

As illustrated in block 216, the system 200 matches the receipt data to the payment vehicle and/or user. In some embodiments, the receipt data comprises the receipt authorization code. The system 200 may, for example, look up the receipt authorization code in a database to determine the associated payment vehicle and/or user. In other examples, the system 200 may identify the user and/or payment vehicle based on various pieces of information found in the receipt data including a portion of a payment vehicle account number such as the last four digits of a credit card number or a check number, time and date of the transaction, merchant identity, user's name, payment authorization code, and the like. The system 200 can use certain pieces of information in the receipt data and compare the pieces of information to account and/or user information stored in the system's databases.

As illustrated in block 218, the system 200 provides a digital receipt to the user in response to receiving the receipt data. The system 200 provides the digital receipt through an online banking system, email, text, mobile banking account, mobile device application, and the like. For example, the authorization code may indicate to the system 200 or to a payment system that the merchant may provide the digital receipt to the user. In some embodiments, the POS device associated with a merchant provides the digital receipt. In such cases, the system 200 and/or payment system may send an email address, phone number, or other contact information to the merchant to enable the merchant to send the digital receipt to the user, or the authorization code and/or rules may include an email address, phone number, fax number, and the like. In other instances, the merchant simply forwards transaction data to the system 200 or a payment system and does not provide the digital receipt directly to the user. In further embodiments, the acquirer, issuer, or merchant provides the digital receipt to the user.

In some embodiments, the routing of the digital receipt is associated with a cost. For example, an entity associated with routing the digital receipt to the user may apply a certain cost such as 20 cents per digital receipt. In other embodiment, the cost associated with routing the digital receipt is waived. For example, the cost for receiving a digital receipt for cash transactions may be waived at certain merchant locations to encourage the user to shop with such merchants. As another example, the cost may be waived for certain payment vehicles/accounts or the routing of the digital receipt may be a free, value-added service associated with these payment vehicles/accounts.

The receipt data includes any information associated with the transaction. Exemplary receipt data includes merchant name and address, store codes, merchant contact information, purchase item descriptions, product categories, product codes, purchase item prices, digital images of the purchase items, total transaction amounts, discount information, tax information, earned reward points, transaction times and dates, return policies, coupons, account data, payment vehicle data, and the like. In some embodiments, the digital receipt comprises at least some of the receipt data. In other embodiments, the digital receipt includes the receipt data and/or additional data not included in the receipt data. For example, the additional data may include historical transaction data such as current and previous purchase trends, projected purchases data, future purchase trends, and the like.

In further embodiments, the system 200 stores the digital receipt in a digital receipt mailbox associated with the user. The system 200 provides the digital receipt upon request or when the associated transaction in an online banking account is viewed by the user.

In some embodiments, the system 200 modifies the receipt data. For example, the system 200 uses the receipt data to format the data in accordance with default preference and/or user preferences, add or delete at least some of the receipt data, calculate purchase amounts, and the like. In another example, the system 200 may reorganize the receipt data so that it is easier for the user to review, use the receipt data in calculations such as total amount for items in a particular category, add additional data such as transactional or account data, or delete portions of the receipt data. In still other embodiments, the system 200 modifies the receipt data based on the receipt authorization code. For example, the receipt authorization code may include user preference and/or default preferences for the digital receipt. Based on the receipt authorization code, the system 200 modifies the transaction data to create the digital receipt.

In other embodiments, another system, such as a purchase system and/or a POS system modifies the receipt data and/or creates the digital receipt. In still other embodiments, the system 200 formats and/or modifies the receipt data based on the one or more rules of the receipt authorization code. For example, the system 200 may compare the transaction criteria of the one or more rules with the transaction data to determine if the receipt data complies with the one or more rules. In one example, the rule may indicate that the system 200 should include purchase amounts for all purchases made at a particular geographical location or store over the past two months if the receipt data indicates that the transaction occurred at the particular geographical location. It will be understood that the system 200 can use any number of transaction criteria associated with the one or more rules described herein to determine whether the receipt data should be modified and/or to determine the modification to be made to the receipt data. The rule used to modify the receipt data may be different from, the same as, or related to the rule used to authorize the electronic receipts as described in more detail below.

In still further embodiments, the system 200 processes a payment dispute with the merchant, a return of an item purchased, a refund of all or a portion of a transaction amount, and/or rewards associated with the transaction of the digital receipt. In other embodiments, the system 200 provides offers for goods or services based on the digital receipt. For example, extended warranties, purchase protection plans, discounts on future purchases, rebates, tax planning services, and the like, may be offered to the user.

Referring now to FIG. 3A, a system and method 300A for routing digital receipts is provided in accordance with various embodiments of the invention. In some embodiments, the one or more steps of the system and method 300A are performed by a payment system, a POS system, and/or the system 200. In one exemplary embodiment, a third party payment system that is separate from the system that distributes digital receipts (e.g., a financial institution) to a user and that is separate from the POS device performs the one or more steps of the system and method 300A or 300B. In this way, the payment system determines whether a digital receipt is authorized and forwards at least some of the data associated with a transaction and/or the digital receipt to receipt distribution system. In other embodiments, the system 300A is associated with an issuer, an acquirer, or a merchant.

As illustrated in block 302, the system 300A receives transaction data associated with a transaction comprising receipt authorization code from a POS device, where the receipt authorization code is associated with one or more rules for digital receipts, the one or more rules comprising transaction criteria. In some embodiments, the POS device is associated with a merchant. In further embodiments, the transaction data is transmitted to a system associated with an acquirer, and the acquirer forwards the transaction data to the system 300A. In some embodiments the transaction criteria includes a purchase amount, purchase frequency, number of purchase items, type of purchase items, merchant identity, period of time of purchase, and/or rewards as described hereinabove with regard to FIG. 2.

The POS device includes POS systems associated with a merchant, a transaction, and the like. In some embodiments, the POS device is the system at the point of sales associated with a user's transaction. The POS device may be, for example, associated with a merchant that is a party to the transaction or a third party to the transaction.

As illustrated in block 304, the system 300A determines whether the transaction complies with the one or more rules. The process ends if the system 300A determines that the transaction does not comply with the one or more rules as shown in block 306. In some embodiments, the system 300A compares the transaction data and the transaction criteria of the one or more rules. For example, the system 300A searches the transaction data using key words, Boolean, purchase authorization codes, transaction codes, store codes, merchant codes, identifiers, and/or formulas to segregate at least some transaction data corresponding to the transaction criteria.

As illustrated in block 308, the system 300A determines receipt data based on the transaction data. The receipt data, in some embodiments, comprises at least a portion of the transaction data that is to be included in the digital receipt. For example, the system 300A may search the transaction data to identify receipt data such as item descriptions, discounts, purchase amounts, and the merchant name and segregate receipt data from the transaction data. In some embodiments, the receipt data is determined based on the first rule. For example, the first rule may include search criteria for identifying the receipt data such that the receipt data can be segregated from the transaction data. As illustrated in block 310, the system 300A sends the receipt data for the transaction to a receipt distribution system. In some embodiments, the receipt distribution system comprises the system 200.

Referring now to FIG. 3B, a system and method 300B for routing digital receipts is provided in accordance with various embodiments of the invention. It will be understood that one or more steps of the system 300B may be performed by one or more of the system 300A; a system associated with a financial institution issuer, an acquirer, a merchant, a payment system; the system 200; and/or a POS device.

As illustrated in block 312, the system 300B receives transaction data associated with a transaction comprising a receipt authorization code from a POS device and/or user, where the receipt authorization code is associated with a first rule for digital receipts and a second rule for digital receipts, the first and second rules comprising transaction criteria. The transaction criteria are described in more detail hereinabove with reference to FIG. 2. As illustrated in block 314, the system 300B determines whether the transaction complies with the first rule. As illustrated in block 316, the system 300B determines that the transaction does not comply with the first rule and the process ends.

Upon determining that the transaction complies with the first rule, the system 300B determines whether the transaction complies with the second rule as illustrated in block 318. As illustrated in blocks 308 and 310, the system 300B determines receipt data based on the transaction data and send the receipt data to a receipt distribution system upon determining that the transaction does not comply with the second rule.

In some embodiments, the first rule authorizes the delivery of digital receipts and the second rule authorizes modification of the data to be included in the digital receipts. As illustrated in block 320, the system 300B modifies at least a portion of the transaction data in response to the determination that the transaction complies with the second rule. In other embodiments, the second rule comprises transaction criteria for modifying the receipt data. The transaction criteria, in some embodiments, includes a purchase amount, purchase frequency, number of purchase items, type of purchase items, merchant identity, period of time of purchase, and/or rewards.

In some embodiments, the first rule comprises a first set of transaction criteria and the second rule comprises a second set of transaction criteria. In some embodiments, at least a portion of the transaction criteria associated with the first rule is the same as at least a portion of the transaction criteria associated with the second rule. For example, the first rule and the second rule may both require that the transaction be associated with a certain merchant or occur during a particular day of the week and within a certain time window.

In other embodiments, at least a portion of the transaction criteria associated with the first rule is different than at least a portion of the transaction criteria associated with the second rule. For example, the first rule may require that the total purchase amount be 20% higher than the total purchase amount of a previous transaction to authorize digital receipts whereas the second rule may require that a category of purchase items be over a predefined purchase amount to authorize modification of the receipt data.

The second rule, in some embodiments, determines the modification to be made to the transaction data/and or digital receipt based on at least a portion of the transaction criteria. For example, the second rule may require that the purchase items in the digital receipt to be arranged into certain categories based on the number of items purchases such as purchases having greater than fifteen items. In other embodiments, an additional rule that is different from the first rule and/or second rule determines the modification to be made to the receipt data and/or digital receipt. For example, a third rule that include transaction criteria that may be different than the transaction criteria of the first rule and/or second rule may be used by the system 300B to determine the changes to make to the transaction data and/or digital receipt. For example, the second rule may authorize the system 300B to send the receipt data to the user or receipt distribution system, while a third rule specifies that the receipt data be modified to include and calculate rewards earned based on the transaction.

As illustrated in block 322, the system 300 sends the modified transaction data for the transaction to a receipt distribution system (e.g., the system 200). Although the embodiment in FIG. 3B illustrates modification of the receipt data by the system 300B, it will be understood that the system 200, POS device, or other system may receive and modify the receipt data. In some embodiments, the receipt distribution system makes additional modifications to the modified receipt data. For example, the receipt distribution system may reformat or reorganize the modified receipt data into a digital receipt before providing the digital receipt to the user. The receipt distribution system, in one example, provides the digital receipt to the user via an online bank account, a web portal, email, text, and the like. The receipt distribution may provide tools or applications via the online or mobile bank account that allows the user to further modify the receipt data.

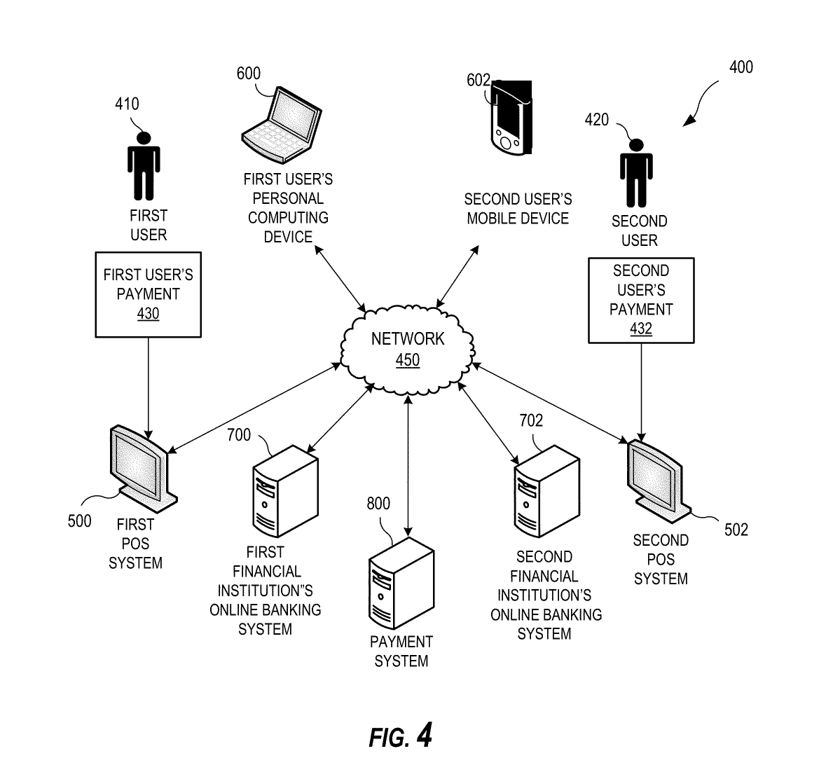

FIG. 4 provides a block diagram illustrating a digital receipt routing system and environment 400, in accordance with an embodiment of the invention. As illustrated in FIG. 4, the digital receipt routing environment 400 includes a first user 410 and a second user 420 where the first user and second user each provide payment for items to be purchased at a point of sale. Each of a first user's payment 430 and a second user's payment 432 includes payment vehicles such as cash, check, credit card, mobile payments, check, gift cards, loyalty cards, and the like. A user of the system may be a person, but may also be a business (e.g., a merchant), customer or a merchant, or any other entity capable of making payments. Although not illustrated in FIG. 4, other systems may also be associated with the digital receipt routing system and environment 400 such as a merchant acquirer, and issuer, other parties or networks associated with a transaction, merchants associated with POS system 500 or POS system 502, and the like.

The environment 400 also includes a personal computing device 600 and a mobile device 602 for the first user 410 and the second user 420, respectively. The personal computing device may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, or other mobile device.

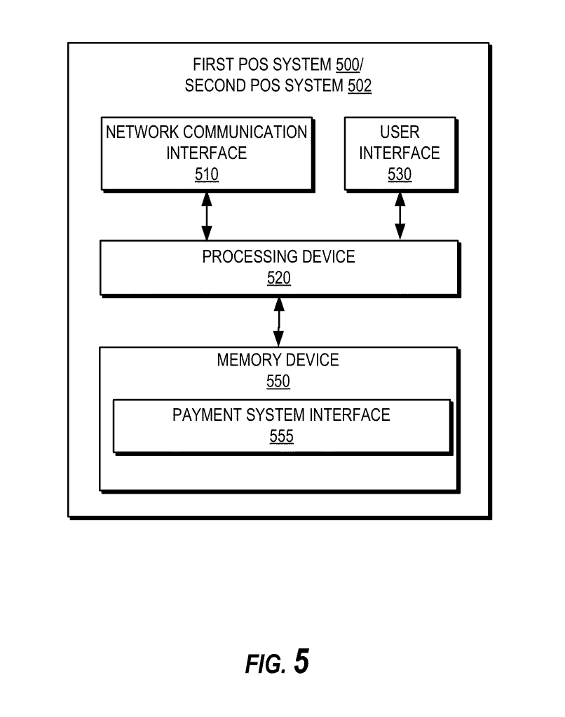

The personal computing device 600 and/or mobile device 602 are configured to communicate over a network 450 with a first financial institution's online banking system 700 or a second financial institution's online banking system 702, and, in some cases, a first point of sales (POS) system 500 or second POS system 502. The first user's personal computing device 600, the first financial institution's online banking system 700, a payment system 800, and the first POS system 500 are each described in greater detail below with reference to FIGS. 5-8. The network 450 may include a local area network (LAN), a wide area network (WAN), and/or a global area network (GAN). The network 450 may provide for wireline, wireless, or a combination of wireline and wireless communication between devices in the network. In one embodiment, the network 450 includes the Internet. In one embodiment, the network 450 includes a wireless telephone mobile network (not shown). In some embodiments, the network 450 is associated with an acquirer, such as a clearing house or merchant's financial institution.

The first POS system 500 and the second POS system 502 process the first user's payment 430 and the second user's payment 432, respectively. In some embodiments, the first user 410 uses the personal computing device 600 or the second user 420 uses the mobile device 602 to make a purchase. For example the first user 410 may use the personal computing device 600 to communicate with the first POS system 500 and make an online or virtual purchase or the second user 420 may use the mobile device 602 to communicate with the second POS system 502 and make a mobile payment. However, the first user 410 and/or the second user 420 need not use the first user's personal computing device 600 or the second user's mobile device 602 to make a purchase and may simply scan a credit card or pay in cash. The first POS system 500 or second POS system 502 may send the payment data inputted by the user to an acquirer and/or the payment system 800. In one embodiment, the payment system 800 is associated with the acquirer. The acquirer, may for example, transmit the payment data to the payment system 800 and the payment system may then forward the payment data to the first financial institution's online banking system 700 or the second financial institution's online banking system 702 to receive authorization for payment. In some embodiments, each of the first financial institution and the second financial institution is an issuer to the transaction.

As described hereinabove, the first user's payment 430 and/or the second user's payment 432 may be associated with a receipt authorization code for digital receipts. The online banking system 700 or the online banking system 702, in some embodiments, sends a payment authorization code along with the receipt authorization code for digital receipts and associated rules to the first POS system 500 or second POS system 502. In some embodiments, the first POS system 500 and/or the second POS system 502 determines that the transaction complies with one or more rules associated with the receipt authorization code and transfers the transaction data to the payment system 800. In other embodiments, the POS systems 500, 502 send the transaction data to the payment system 800 and the payment system 800 determines whether the transaction data complies with the one or more rules of the receipt authorization code. In other embodiments, the POS devices 500, 502 send the transaction data to the online banking systems 700, 702.

As shown in FIG. 4, the payment system 800 compares the transaction data and transaction criteria of the one or more rules to determine that the transaction data complies with the one or more rules of the receipt authorization code. In the illustrated embodiment, the payment system 800 transfers receipt data, which includes at least some of the transaction data, to each of the first financial institution's online banking system 700 and the second financial institution' online banking system 702. Each of the online banking system 700 and the online banking system 702 transfers a digital receipt, which includes at least some of the receipt data, to the personal computing device 600 or the mobile device 602 via the network 450.

In general, the first user's personal computing device 600 is configured to connect with the network 450 to log the first user 410 into an online banking system 700 of a first financial institution. The second user's mobile device 602 is also configured to connect with the network 450 to log the second user 420 into an online banking system 702 of a second financial institution. In some embodiments, the first user 410 and/or the second user 420 accesses the digital receipt via the online banking systems 700, 702. The online banking system 700 or the online banking system 702 involves authentication of a user in order to access the user's account on the online banking system 700 or the online banking system 702. For example, the online banking system 700 or the online banking system 702 is a system where the first user 410 or second user 420 logs into his/her account such that the first user 410 or other entity can access data that is associated with the first user 410 or second user 420. For example, in one embodiment of the invention, the online banking system 700 is an online banking system maintained by a financial institution. In such an embodiment, the first user 410 can use the personal computing device 600 to log into the online banking system 700 to access an online banking account. Logging into the online banking system 700 or the online banking system 702 generally requires that the first user 410 or second user 420 authenticate his/her identity using a user name, a passcode, a cookie, a biometric identifier, a private key, a token, and/or another authentication mechanism that is provided by the first user 410 or second user 420 to the online banking system 700 or the online banking system 702 via the personal computing device 600 or the mobile device 602.

Each of the first financial institution's banking system 700 and the second financial institution's online banking system 702 is in network communication with other devices, such as first POS system 500 or second POS system 502, a payment system 800, a personal computing device 600 that is configured to communicate with the network 450 to log the first user 410 into the online banking system 700, and/or the mobile device 602 that is configured to communicate with the network 450 to log the second user 420 into the online banking system 702.

In some embodiments of the invention, the payment system 800 is configured to be controlled and managed by one or more third-party data providers (not shown in FIG. 4) over the network 450. In other embodiments, the payment system 800 is configured to be controlled and managed over the network 450 by the same entity that maintains the first financial institution's online banking system 700 of the second financial institution's online banking system 702. In other embodiments, the payment system 800 is configured to be controlled and managed over the network 450 by the financial institution implementing the online payment system of the present invention.

FIG. 5 provides a block diagram illustrating the first POS system 500 or the second system 502 of FIG. 4 in more detail, in accordance with some embodiments. For the sake of simplicity, the first POS system 500 or the second POS system 502 illustrated in FIG. 5 will be referred to as the POS system 500. The POS system 500 is maintained by a merchant and includes a POS device that is communication with a server. In some embodiments, the POS system 500 is configured to scan or enter items to be purchased and process payments.

The POS system 500 includes various features, such as a network communication interface 510, a processing device 520, a user interface 530, and a memory device 550. The network communication interface 510 includes a device that allows the POS system 500 to communicate over the network 450 (shown in FIG. 4). In addition, a payment system interface 555 is stored in the memory device 550. The payment system interface 555 allows the POS system 500 to communicate with an application of the payment system 800.

As used herein, a “processing device,” such as the processing device 520 or the processing device 620, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 530 or 630 generally includes a plurality of interface devices that allow a customer to input commands and data to direct the processing device to execute instructions. As such, the user interface 530 employs certain input and output devices to input data received from the merchant, the first user 410 or the second user 420 or output data to the merchant, the first user 410 or the second user 420. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 550 or 650 generally refers to a device or combination of devices that store one or more forms of computer-readable media and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 20 when it carries out its functions described herein.

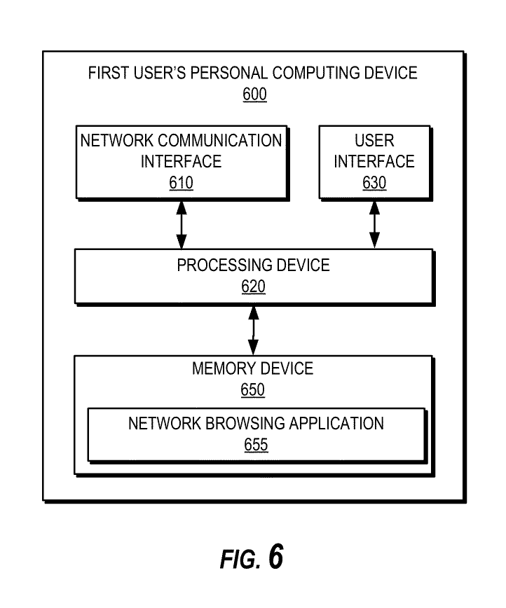

Referring now to FIG. 6, the personal computing device 600 associated with the first user 410 also includes various features, such as a network communication interface 610, a processing device 620, a user interface 630, and a memory device 650. The network communication interface 610 includes a device that allows the personal computing device 600 to communicate over the network 450 (shown in FIG. 4). In addition, a network browsing application 655 is stored in the memory device 650. The network browsing application 655 provides for the user to establish network communication for the purpose of registering and account and/or alias with the online payment system and/or receiving online payment and/or accessing a digital receipt, in accordance with embodiments of the present invention.

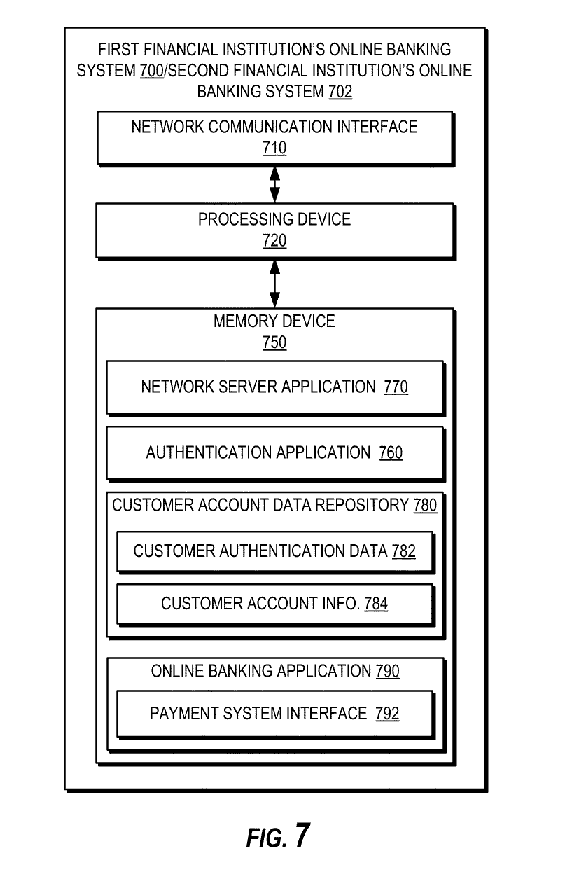

FIG. 7 provides a block diagram illustrating the online banking system 700 and/or the online banking system 702 in greater detail, in accordance with embodiments of the invention. For the sake of simplicity, the online banking system 700 and/or the online banking system 702 will be simply referred to as the online banking system 700. As illustrated in FIG. 7, in one embodiment of the invention, the online banking system 700 includes a processing device 720 operatively coupled to a network communication interface 710 and a memory device 750. In certain embodiments, the online banking system 700 is operated by a first entity, such as a financial institution, while in other embodiments; the online banking system 700 is operated by an entity other than a financial institution.

It should be understood that the memory device 750 may include one or more databases or other data structures/repositories. The memory device 750 also includes computer-executable program code that instructs the processing device 720 to operate the network communication interface 710 to perform certain communication functions of the online banking system 700 described herein. For example, in one embodiment of the online banking system 700, the memory device 750 includes, but is not limited to, a network server application 770, an authentication application 760, a customer account data repository 780, which includes customer authentication data 782 and customer account information 784, and an online banking application 790, which includes an payment system interface 792 and other computer-executable instructions or other data. The computer-executable program code of the network server application 770, the authentication application 760, or the online banking application 790 may instruct the processing device 720 to perform certain logic, data-processing, and data-storing functions of the online system 700 described herein, as well as communication functions of the online banking system 700.

In one embodiment, the customer account data repository 780 includes customer authentication data 782 and customer account information 784. The network server application 770, the authentication application 760, and the online banking application 790 are configured to implement customer account information 784, the customer authentication data 782, and the payment system interface 792 when authenticating the user to the online banking system 700.

As used herein, a “communication interface” generally includes a modem, server, transceiver, and/or other device for communicating with other devices on a network, and/or a user interface for communicating with one or more customers. Referring again to FIG. 7, the network communication interface 710 is a communication interface having one or more communication devices configured to communicate with one or more other devices on the network 450, such as the mobile device 602 or personal computing device 600, the online banking systems 700, 702, the POS devices 500, 502, and the payment system 800. The processing device 720 is configured to use the network communication interface 710 to transmit and/or receive data and/or commands to and/or from the other devices connected to the network 450.

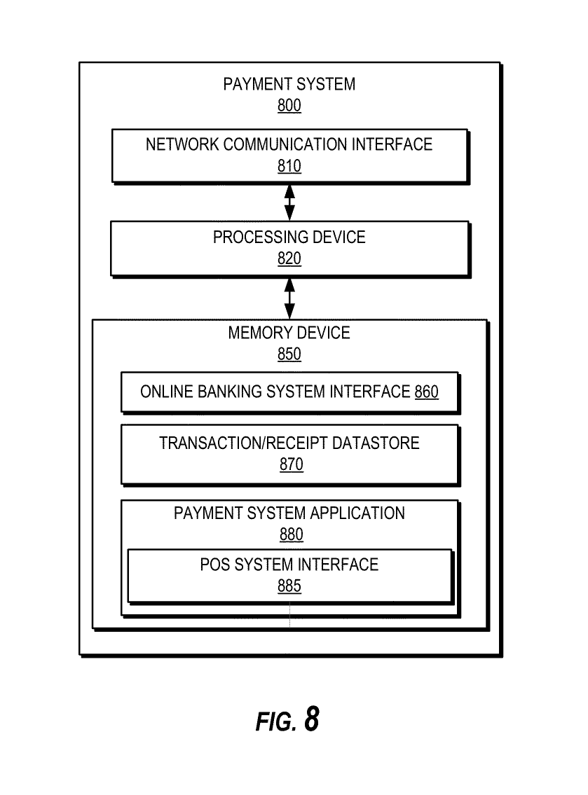

FIG. 8 provides a block diagram illustrating the payment system 800 of FIG. 4, in accordance with an embodiment of the invention. In one embodiment of the invention, the payment system 800 is operated by a second entity that is a different or separate entity from the first entity (e.g., the financial institution) that, in one embodiment of the invention, implements the online banking system 700. In one embodiment, the payment system 800 could be part of the online banking system 700 or the online banking system 702. In another embodiment, the payment system 800 is a distinct entity from the online banking system 700 or the online banking system 702. As illustrated in FIG. 8, the payment system 800 generally includes, but is not limited to, a network communication interface 810, a processing device 820, and a memory device 850. The processing device 820 is operatively coupled to the network communication interface 810 and the memory device 850. In one embodiment of the payment system 800, the memory device 850 stores, but is not limited to, an online banking system interface 860 and a transaction/receipt data store 870. The transaction/receipt data store 870 stores data including, but not limited to, transaction data received from the POS system 500, 502 or the online banking systems 700, 702, receipt data, digital receipts, receipt authorization codes, and the like. In one embodiment of the invention, both the online banking system interface 860 and the transaction/receipt data store 870 may associate with applications having computer-executable program code that instructs the processing device 820 to operate the network communication interface 810 to perform certain communication functions involving the transaction/receipt data store 870 described herein. In one embodiment, the computer-executable program code of an application associated with the transaction/receipt data store 870 may also instruct the processing device 820 to perform certain logic, data processing, and data storing functions of the application associated with the transaction/receipt data store 870 described herein. In other embodiments of the payment system 800, the memory device 850 stores, but is not limited to, a payment system application 880 and a POS system interface 885.

The network communication interface 810 is a communication interface having one or more communication devices configured to communicate with one or more other devices on the network 450. The processing device 820 is configured to use the network communication interface 810 to receive information from and/or provide information and commands to the mobile device 602 or personal computing device 600, the POS systems 500, 502, the payment system 800, the online banking systems 700, 702 and/or other devices via the network 450. In some embodiments, the processing device 820 also uses the network communication interface 810 to access other devices on the network 450, such as one or more web servers of one or more third-party data providers. In some embodiments, one or more of the devices described herein may be operated by a second entity so that the third-party controls the various functions involving the payment system 800. For example, in one embodiment of the invention, although the online system 700 is operated by a first entity (e.g., a financial institution), a second entity operates the payment system 800 that stores the receipt details for the customer's financial institution accounts and other information about customers.

As described above, the processing device 820 is configured to use the network communication interface 810 to gather data from the various data sources. The processing device 820 stores the data that it receives in the memory device 850. In this regard, in one embodiment of the invention, the memory device 850 includes datastores that include, for example: (1) aliases for customer financial institution account numbers and routing information, (2) information about sending and receiving users' mobile device numbers, email addresses, or other contact information, which may have been received from the online banking system 700 or the online banking system 702; (3) a list of customer IDs or authentication data received from the online banking system 700 or the online banking system 702; and/or (4) customer credentials (e.g., a customer ID) received from the personal computing device 600, the mobile device 602, or received from the online system in response to the user accessing the online banking system 700 or the online banking system 702.

In some embodiments, an application server is provided to support various supporting systems on the network 450, including the wireless telephone mobile network. The application server includes a network communication interface, a processing device, and a memory device. The network communication interface and the processing device are similar to the previously described network communication interface 710 processing device 720. For example, the processing device is operatively coupled to the network communication interface and the memory device. In one embodiment of the application server, the memory device includes a network browsing application having computer-executable program codes that instruct the processing device to operate the network communication interface to perform certain communication functions of the application download server described herein. In some embodiments, the application download server provides applications that are to be downloaded to a user's mobile device or personal computing device.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for routing digital receipts to a user, the system comprising:
a computer apparatus including a processor and a memory; and
a digital receipt router software module stored in the memory, comprising executable instructions that when executed by the processor cause the processor to:
receive transaction data associated with a transaction comprising a receipt authorization code for authoring delivery of the digital receipts, wherein the receipt authorization code is associated with a first rule comprising a first set of transaction criteria;
compare the first set of transaction criteria and the transaction data;
determine that the transaction complies with the first rule based on the comparison of the first set of transaction criteria and the transaction data; and
segregate receipt data from the transaction data based on the first rule.

2. The system of claim 1, wherein the module is further configured to:
send the receipt data to a receipt distribution system that is in communication with the system.

3. The system of claim 1, wherein the receipt authorization code is associated with a second rule for modifying the data to be included in the digital receipts, the second rule comprising a second set of transaction criteria.

4. The system of claim 3, wherein at least a portion of the second set of transaction criteria is the same as at least a portion of first set of transaction criteria.

5. The system of claim 3, wherein the module is further configured to:
compare the transaction data and the second set of transaction criteria;
determine that the transaction complies with the second rule;
modify the receipt data in response to determining that the second set of transaction criteria complies with the second rule; and
send the modified receipt data to a distribution system that is in communication with the system.

6. The system of claim 5, wherein the module is further configured to:
identify purchased items of the transaction; and
segregate the purchased items into one or more categories.

7. The system of claim 1, wherein the transaction data is received from a point of sales device that is in communication with the system.

8. The system of claim 1, wherein the first set of transaction criteria comprises at least one of a purchase amount, a purchase frequency, a number of purchase items, a type of purchase item, a merchant identity, a period of time of purchase, and rewards.

9. A computer program product for routing digital receipts to a user, the computer program product comprising:
a computer readable storage medium having computer readable program code embodied therewith, the computer readable program code comprising:
a computer readable program code configured to receive transaction data comprising a receipt authorization code for authorizing delivery of the digital receipts, wherein the receipt authorization code is associated with a first rule comprising a first set of transaction criteria;
a computer readable program code configured to compare the first set of transaction criteria and the transaction data;
a computer readable program code configured to determine that the transaction complies with the first rule based on the comparison of the first set of transaction criteria and the transaction data; and
a computer readable program code configured to segregate receipt data from the transaction data based on the first rule.

10. The computer program product of claim 9, the computer program product further comprising a computer readable program code configured to send the receipt data to a receipt distribution system that is in communication with the system.

11. The computer program product of claim 9, wherein the receipt authorization code is associated with a second rule comprising second set of transaction criteria for modifying the data to be included in the digital receipts.

12. The computer program product of claim 11, the computer program product further comprising a computer readable program code configured to:
compare the transaction data and the second set of transaction criteria;
determine that the transaction complies with the second rule;
modify the receipt data based on terms of the second rule; and
send the modified receipt data to a distribution system that is in communication with the system.

13. The computer program product of claim 9, wherein the first set of transaction criteria comprises at least one of a purchase amount, a purchase frequency, a number of purchase items, a type of purchase item, a merchant identity, a period of time of purchase, and rewards.

14. The computer program product of claim 9, wherein at least a portion of the second set of transaction criteria is the same as at least a portion of first set of transaction criteria.

15. The computer program product of claim 9, wherein the transaction data is received from a point of sales device that is in communication with the system.

16. A computer implemented method for routing digital receipts to a user, the method being performed by a computer processor, wherein the computer processor operates on specifically configured computer program code that cause the processor to perform the operations of:
receiving transaction data associated with a transaction comprising a receipt authorization code for authoring delivery of the digital receipts, wherein the receipt authorization code is associated with a first rule comprising a first set of transaction criteria;
comparing the first set of transaction criteria and the transaction data;
determining that the transaction complies with the first rule based on the comparison of the first set of transaction criteria and the transaction data; and
segregating receipt data from the transaction data based on the first rule.

17. The method of claim 16, the processor being further configured to perform the operations of:
sending the receipt data to a receipt distribution system that is in communication with the system.

18. The method of claim 16, wherein the receipt authorization code is associated with a second rule comprising second set of transaction criteria for modifying the data to be included in the digital receipts.

19. The method of claim 18, the processor being further configured to perform the operations of:
comparing the transaction data and the second set of transaction criteria;
determining that the transaction complies with the second rule;
modifying the receipt data based on terms of the second rule; and
sending the modified receipt data to a distribution system that is in communication with the system.

20. The method of claim 18, wherein the first set of transaction criteria is different from the second set of transaction criteria.
